(19) United States
(12) Patent Application Publication
(10) Pub. No.: US 2013/0080356 A1
(43) Pub. Date: Mar. 28, 2013

(54) APPARATUS AND A METHOD FOR OPERATING A SERVICE, AND A NON-TRANSITORY COMPUTER READABLE MEDIUM THEREOF

(71) Applicants: Yu Kaneko, Kanagawa-ken (JP); Tomonori Maegawa, Tokyo (JP); Shigeo Matsuzawa, Tokyo (JP)

(72) Inventors: Yu Kaneko, Kanagawa-ken (JP); Tomonori Maegawa, Tokyo (JP); Shigeo Matsuzawa, Tokyo (JP)

(21) Appl. No.: 13/537,722

(22) Filed: Jun. 29, 2012

(30) Foreign Application Priority Data
Sep. 27, 2011 (JP) P2011-211659

(51) Int. Cl. G06Q 50/06

(52) U.S. Cl. 705/412

(57) ABSTRACT

According to one embodiment, an environment provider storage stores a plurality of account methods corresponding to environment providers providing service execution environments. Each account method is a method for calculating a usage fee for each service execution environment. A resource consumption storage stores a plurality of resource consumptions corresponding to run modes. Each run mode is an operation pattern for each service execution environment to execute the service. Each resource consumption is a consumption of resources of the service execution environment while executing the service in each run mode. A calculation unit calculates usage fees based on combinations of one of the account methods corresponding to the environment providers and one of the resource consumptions corresponding to the run modes. An integrated operation unit selects at least one combination of a selected environment provider and a selected run mode, based on the usage fees calculated by the calculation unit.

### CROSS-REFERENCE TO RELATED APPLICATION

This application is based upon and claims the benefit of priority from Japanese Patent Application No. 2011-211659, filed on Sep. 27, 2011; the entire contents of which are incorporated herein by reference.

### FIELD

Embodiments described herein relate generally to an apparatus and a method for operating a service, and a non-transitory computer readable medium thereof.

### BACKGROUND

As to medium and minor scaled buildings or detached houses, a remote energy saving service is provided. In the remote energy saving service, a service provider makes the energy saving service operate on a server installed in a data center. By controlling and monitoring a plurality of buildings via a network, the energy saving thereof is realized. As the energy saving service, a plurality of types (such as a comfort air conditioning control and a comfort lighting control) exists.

A method for the service provider to make the energy saving service operate is classified into following two patterns.

As a first method, on a server as a property of the service provider, the service provider makes the energy saving service operate.

As a second method, the service provider rents (borrows) an execution environment from a rental business operator to provide the execution environment of a service (the rental business operator is called a hosting service business operator or an environment provider). Then, the service provider makes the service operate on this execution environment. Moreover, the execution environment is an environment to execute the service. The execution environment prepares a plurality of servers, and executes the service on the server.

When the service provider provides the service, it is important to reduce a cost required for providing the service.

As to the first method, a method for reducing the cost is conventionally disclosed. When the service provider makes the energy saving service operate on a server prepared by the service provider, reduction of the number of servers is related with reduction of the cost. In order to reduce the number of servers to be operated, it is important that consumption of resources (such as a CPU, a memory, a disk, a network) of each server does not vary irrespective of time. As a conventional technique, a method for smoothing the resource consumption is disclosed.

On the other hand, as to the second method, a method for reducing the cost is not disclosed as a conventional technique. When the service provider makes the energy saving service operate on the execution environment rented from the hosting service business operator, lowering of rental fee (usage fee) is related with reduction of the cost. The rental fee is determined based on an account method of rental fee by the hosting service business operator. Then, the account method of rental fee is different by respective hosting service business operators. According to the account method of rental fee, even if the number of servers to be operated is reduced by smoothing the resource consumption in the same way as the first method, the usage fee does not often lower. For example, as the account method, when the usage fee rises in proportion to a total of the resource consumption, even if smoothing of the resource consumption is executed, the usage fee does not often lower. Because, when smoothing of the resource consumption is executed, in comparison with the case of not smoothing, a peak of the resource consumption becomes small. However, a total of the resource consumption often increases by overhead for the smoothing.

### BRIEF DESCRIPTION OF THE DRAWINGS

FIG. 1 is a block diagram of a service operation apparatus 100 according to the first embodiment.

FIG. 2 is a block diagram of a hosting service business operator system 200A according to the first embodiment.

FIG. 3 is one example of information stored in a hosting service business operator storage 101 in FIG. 1.

FIG. 4 is one example of information stored in a resource consumption storage 103 in FIG. 3.

FIG. 5 is a flow chart of processing of the service operation apparatus 100.

FIG. 6 is a block diagram of a service operation apparatus 2100 according to the second embodiment.

FIG. 7 is a flow chart of processing of an account method acquisition unit 2101 in FIG. 6.

FIG. 8 is a flow chart of processing of a resource consumption acquisition unit 2102 in FIG. 6.

FIG. 9 is a flow chart of processing of the service operation apparatus 2100.

### DETAILED DESCRIPTION

According to one embodiment, a service operation apparatus includes an environment provider storage, a resource consumption storage, a calculation unit, and an integrated operation unit. The environment provider storage stores a plurality of account methods corresponding to environment providers providing service execution environments. Each account method is a method for calculating a usage fee for each service execution environment. The resource consumption storage stores a plurality of resource consumptions corresponding to run modes. Each run mode is an operation pattern for each service execution environment to execute the service. Each resource consumption is a consumption of resources of the service execution environment while executing the service in each run mode. The calculation unit is configured to calculate usage fees based on combinations of one of the account methods corresponding to the environment providers and one of the resource consumptions corresponding to the run modes. The integrated operation unit is configured to select at least one combination of a selected environment provider and a selected run mode, based on the usage fees calculated by the calculation unit.

Various embodiments will be described hereinafter with reference to the accompanying drawings.

### The First Embodiment

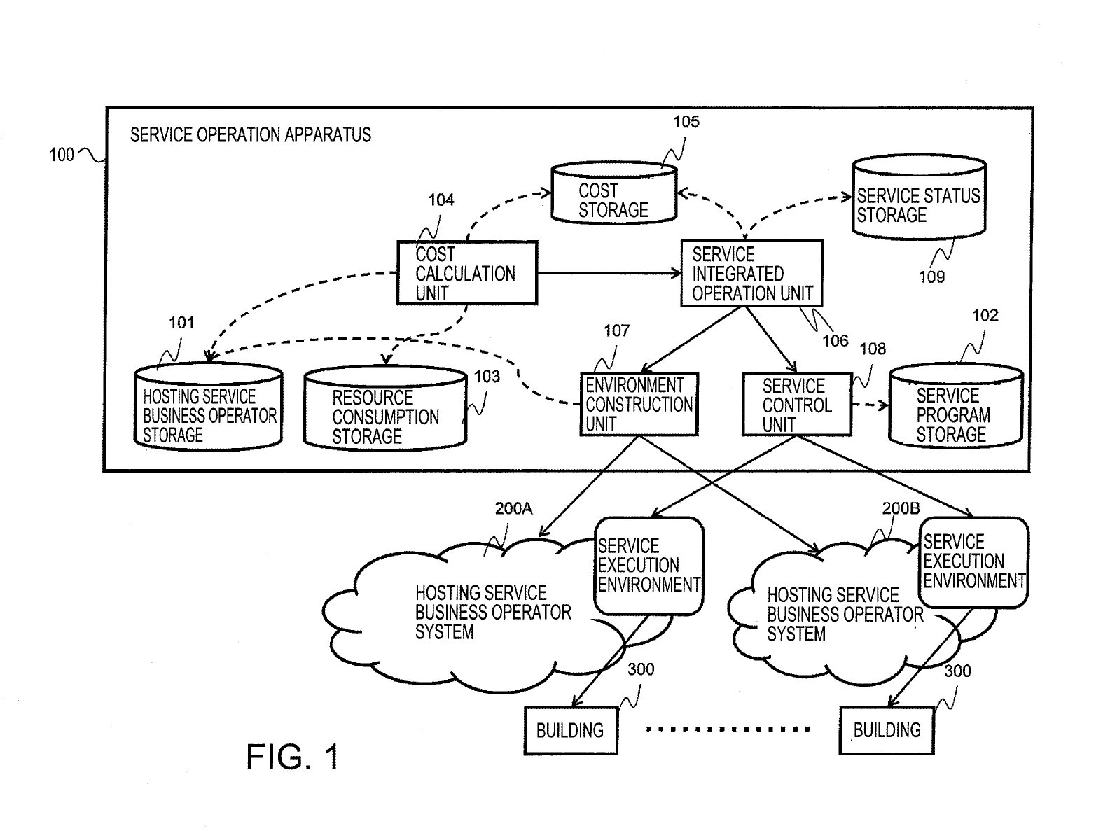

FIG. 1 is a block diagram of a system according to the first embodiment. The system of the first embodiment includes a service operation apparatus 100, hosting service business operator systems 200A and 200B, and a plurality of buildings 300. The service operation apparatus 100 is connected with the hosting service business operator systems 200A and 200B via a network. Furthermore, the hosting service business operator systems 200A and 200B are respectively connected with any of the plurality of buildings 300 via a network.

The service operation apparatus 100 selects the hosting service business operator system, constructs a service execution environment on the hosting service business operator system selected, and makes an energy saving service on the service execution environment. Furthermore, the service operation apparatus 100 selects a run mode to execute the energy saving service on the service execution environment, and sets the run mode to the energy saving service. Moreover, in the first embodiment, the service execution environment is a virtual server constructed in the hosting service business operator system.

Here, in case of selecting a combination of the service execution environment and the run mode, the service operation apparatus 100 selects a combination of a hosting service business operator (environment provider) and a run mode to make a usage fee cheap. How to estimate the usage fee and how to select the combination of the service execution environment and the run mode are explained afterwards.

The hosting service business operator system 200A and 200B are a system for the hosting service business operator to provide a service execution environment, and also a system to construct the service execution environment (virtual server) which executes the energy saving service. As shown in FIG. 1, for example, the service execution environment is constructed on the hosting service business operator system 200A or 200B. The hosting service business operator system 200A and 200B are respectively provided by different hosting service business operator. The virtual server is provided by each hosting service business operator. By utilizing a service to generate the virtual server, the virtual server can be constructed. In the first embodiment, as a service to generate the virtual server, createVM service is imagined.

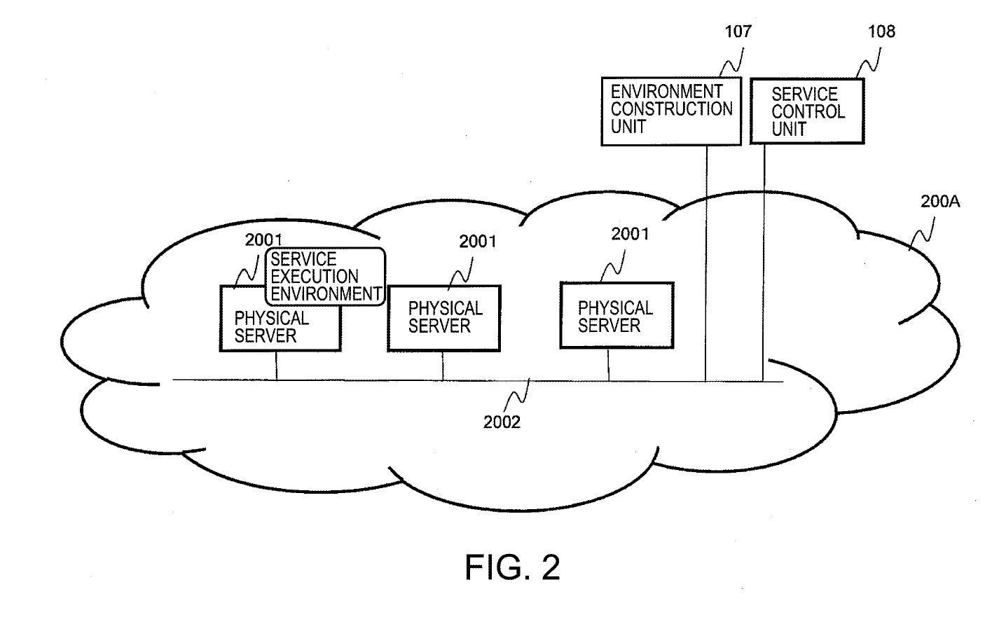

FIG. 2 is a block diagram showing component of the hosting service business operator system 200A. The hosting service business operator system 200B has the same component as FIG. 1. In the hosting service business operator system 200A, a plurality of physical servers 2001 is connected via a network 2002. Furthermore, the plurality of physical servers 2001 is connected with an environment construction unit 107 and a service control unit 108 via the network 2002. When the service operation apparatus 100 utilizes createVM service, the hosting service business operator system 200A constructs a virtual server on any of the plurality of physical servers 2001. In this case, one virtual server may be constructed, and a plurality of virtual servers may be constructed. Then, the service operation apparatus 100 executes the energy saving service for the building 300 on the virtual server.

Here, the energy saving service is a service to be executed on the service execution environment of the hosting service business operator system selected by the service operation apparatus 100. As the energy saving service, a plurality of types (such as a comfort air conditioning control and a comfort lighting control) exists.

By providing the energy saving service, the building realizes an energy saving. For example, if the energy saving service is a comfort air conditioning control, an energy saving by air conditioning control is realized.

Next, component of the service operation apparatus 100 is explained. The service operation apparatus 100 includes a hosting service business operator storage 101, a service program storage 102, a resource consumption storage 103, a cost calculation unit 104, a cost storage 105, a service integrated operation unit 106, an environment construction unit 107, a service control unit 108, and a service status storage 109.

The hosting service business operator storage 101 stores a business operator ID, an account method of usage fee, a server spec, and an environment construction method for each hosting service business operator.

The business operator ID is an ID to uniquely identify the hosting service business operator (environment provider).

The account method is a method for determining a usage fee of the service execution environment. This account method is previously determined for each hosting service business operator.

The server spec is information related to a performance of a virtual server provided by the hosting service business operator.

The environment construction method is a method for constructing the service execution environment (virtual server).

Here, the account method is represented by a calculation formula of which a variable is a resource consumption of the service execution environment and a constant is a unit price of the resource. For example, the account method is represented by a calculation formula (1) or (2). In the calculation formula (1), the resource consumption is the number of servers utilized, and the unit price of resource is a unit price (usage fee per one virtual server) of a server of the virtual server. Furthermore, in the calculation formula (2), the resource consumption is a time (period) while the virtual server has utilized the virtual server, and the unit price of resource is a unit price of the CPU. In the calculation formulas (1) and (2), the unit price of resource (a unit price of server, a unit price of traffic, or a unit price of CPU) is a constant determined by the hosting service business operator. On the other hand, the resource consumption (the number of servers utilized, a time while the CPU is utilized, a traffic utilized) is a variable different by each combination of the energy saving service and the run mode. How to calculate the resource consumption is explained afterwards.

Usage fee of one day=(the number of servers utilized)×(unit price of server)+(traffic)×(unit price of traffic) (1)

Usage fee=(time of CPU utilized)×(unit price of CPU)+(traffic)×(unit price of traffic) (2)

The calculation formula (1) is explained in detail. In the calculation formula (1), assume that the unit price of server is a usage fee of one server (virtual server) in one hour. In this case, the number of virtual servers utilized is calculated by a calculation formula (3). In the calculation formula (3), the number of virtual servers utilized is a total of the number of servers per one hour.

The number of servers utilized is the number of servers utilized at “0˜1” o'clock+the number of servers utilized at “1˜2” o'clock+the number of servers utilized at “2˜3” o'clock+ . . . +the number of servers utilized at “23˜0” o'clock (3)

Moreover, some hosting service business operator sets the unit price of server as not “a unit of one hour” but “a unit of one day” or “a unit of one month”. Accordingly, a method for calculating the number of servers is changed based on the unit price of server.

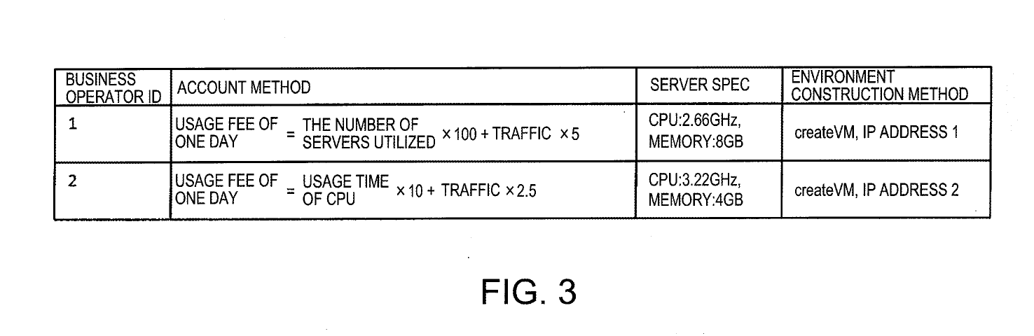

FIG. 3 shows one example of information stored in the hosting service business operator storage 101. In FIG. 3, the account method of the business operator 1 is determined by the calculation formula (1), the unit price of server is 100, and the unit price of traffic is 5. Furthermore, in FIG. 3, the account method of the business operator 2 is determined by the calculation formula (2), the unit price of server is 10, and the unit price of traffic is 2.5.

Furthermore, in FIG. 3, as the environment construction method (a method for generating a virtual server), the business operators 1 and 2 respectively provide createVM service. The business operator 1 provides createVM service with a server having IP address 1. The business operator 2 provides createVM service with a server having IP address 2. By utilizing createVM service, the service operation apparatus 100 can create a virtual server on a hosting service business operator system of the business operator 1, and acquire an IP address of the virtual server created. Moreover, a method for constructing the virtual server is not limited to createVM service. Various methods such as a method for working with remote log-in or a method for operating from Web browser may be used.

The service program storage 102 stores information related to an energy saving service to be executed. This information includes an energy saving service ID, an execution program, and configuration information.

The energy saving service ID is an ID to uniquely identify the energy saving service.

The execution program is a program to execute the energy saving service.

The configuration information is information to configure the energy saving service. Concretely, it is a configuration file utilized by the energy saving service.

The resource consumption storage 103 stores information of a resource consumption of the energy saving service. The resource consumption is a usage amount of each time segment of a resource when the energy saving service is executed. For example, the resource is a CPU, a memory, a disk, a network band, or the number of servers. In the first embodiment, as the resource consumption, a usage amount of each time segment of the CPU, the network band, and the number of servers are imagined. These values are utilized for calculating the calculation formulas (1), (2) and (3). The resource consumption may be previously acquired by executing an operation test or from the virtual server executing the energy saving service.

The resource consumption storage 103 stores an energy saving service ID, a run mode, a server spec, and resource consumptions (a CPU time, a traffic, the number of servers required).

The energy saving service ID is an ID to uniquely identify the energy saving service.

The run mode is an operation pattern to execute the energy saving service. The resource consumption changes depending on the run mode. Accordingly, the resource consumption is stored for each run mode. For example, the run mode is “whether to smooth the resource consumption”, “whether to compress data to be transmitted/received for communication” and so on. The run mode is not limited to these two examples. As the run mode, another mode may be imagined. Another mode affects on the resource consumption.

The server spec is a specification of a server utilized for searching the resource consumption. The resource consumption changes depending on the server spec. Accordingly, the resource consumption is stored for each server spec.

The CPU time is a period while the energy saving service utilizes a CPU. For example, it is a time while the CPU is consumed in one day.

The traffic is a quantity of data to be transmitted/received by executing the energy saving service. For example, it is traffic occurred in one day.

The number of servers required is the number of virtual servers necessary for executing the energy saving service. For example, it is the number of virtual servers per one hour in one day.

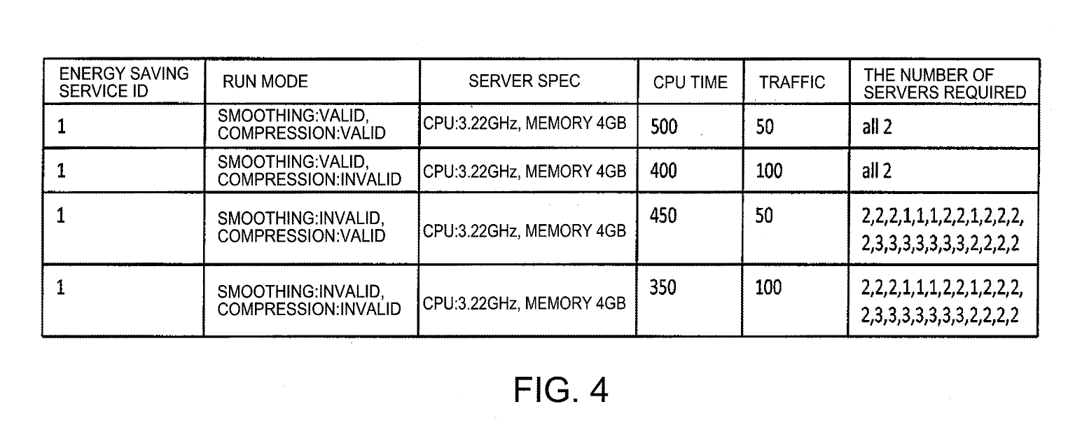

FIG. 4 shows one example of information stored in the resource consumption storage 103. For example, in a first entry of FIG. 4, the run mode represents “resource consumption is smoothed” and “data is compressed for communication (transmitted/received)”. Furthermore, in the first entry of FIG. 4, in comparison with other entries, the CPU time is the longest, and the traffic is the smallest. Furthermore, irrespective of time, the number of servers required is two. Furthermore, in a third entry and fourth entry of FIG. 4, the resource consumption is an example in case that the run mode is “resource consumption is not smoothed”. In this case, the number of servers required changes with passage of time (In FIG. 4, the number of servers is described by segmenting with a comma per one hour). Moreover, in FIG. 4, an example that the resource consumption consumed in one day is stored is shown. However, based on the account method of the hosting service business operator, the resource consumption per one month may be stored.

By referring to information stored in the hosting service business operator storage 101 and the resource consumption storage 103, the cost calculation unit 104 calculates a cost occurred by operation of the energy saving service.

The cost storage 105 stores a cost (usage fee) calculated by the cost calculation unit 104, with the business operator ID and the run mode thereof. Briefly, the cost storage 105 stores the energy saving service ID, the business operator ID, the run mode, and the usage fee.

Based on the usage fee stored in the cost storage 105, the service integrated operation unit 106 selects the hosting service business operator system and the run mode to construct the execution environment of the energy saving service. Furthermore, by outputting a command to the environment construction unit 107 and the service control unit 108, the service integrated operation unit 106 realizes construction of the service execution environment (a virtual server) and configuration of the run mode to execute the energy saving service on the virtual server.

Based on the command from the service integrated operation unit 106, the environment construction unit 107 constructs a service execution environment to execute the energy saving service. Concretely, by using Web service (createVM service), the environment construction unit 107 creates a virtual server (service execution environment) on the hosting service business operator system. Furthermore, the environment construction unit 107 installs a middleware and a library necessary for executing the energy saving service in the virtual server. Moreover, install of the middleware and the library can be easily automated by using shell script.

Based on the command from the service integrated operation unit 106, by referring to the service program storage 102, the service control unit 108 installs the energy saving service in the virtual server, and sets the run mode.

The service status storage 109 stores an operation status of the service. Concretely, the operation status is represented by the business operator ID of a business operator who presently provides the service execution environment, the run mode of the energy saving service presently operating, and network information such as an ID and a port number of the server executing the energy saving service.

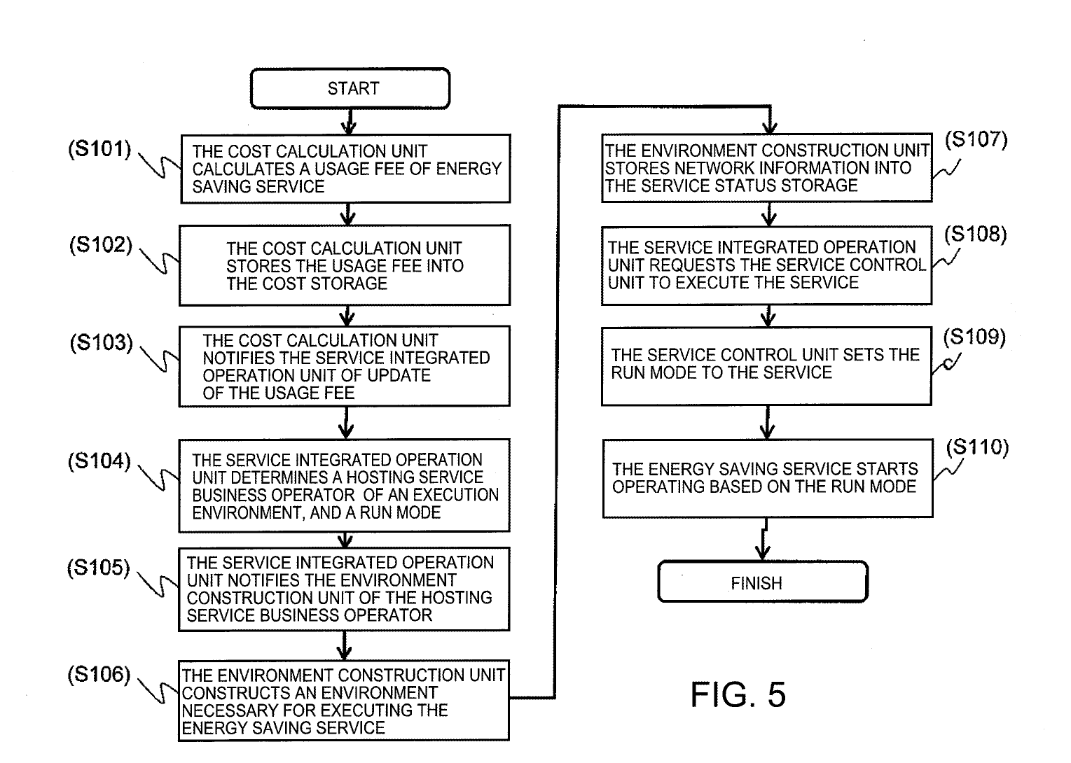

Thus far, component of the service operation apparatus 100 is already explained. Next, an operation method of the service operation apparatus 100 is explained. FIG. 5 is a flow chart of processing for the service operation apparatus 100 to operate the energy saving service 1.

First, the cost calculation unit 104 calculates a usage fee of the energy saving service 1 for each hosting service business operator (S101). The usage fee is calculated by substituting the resource consumption (stored in the resource consumption storage 103) for a calculation formula of the account method (stored in the hosting service business operator storage 101). For example, if the run mode of the energy saving service 1 is (smoothing: valid, compression: valid), as shown in FIG. 4, the CPU time is 500, the traffic is 50, and the number of servers required is always 2 irrespective of time. In this case, by using the account method of the business operator 1 in FIG. 3, usage fee of one day is calculated as “(2×24)×100+50×5=5050”. Furthermore, by using the account method of the business operator 2 in FIG. 3, a usage fee of one day is calculated as “(500)×10+50×2.5=5125”. Briefly, a cost to utilize the service execution environment of the business operator 1 is lower. In this way, the usage fee is calculated for each combination of four run modes {(smoothing: valid, compression: valid), (smoothing: valid, compression: invalid), (smoothing: invalid, compression: valid), (smoothing: invalid, compression: invalid)} and two account methods of business operators 1 and 2.

Next, the cost calculation unit 104 stores all usage fees, the business operator ID and the run mode thereof, into the cost storage 105 (S102).

Next, the cost calculation unit 104 notifies the service integrated operation unit 106 of update of the usage fee related to the energy saving service 1 (S103).

Next, by referring to the cost storage 105, the service integrated operation unit 106 selects one combination of the business operator and the run mode of which the usage fee to execute the energy saving service 1 is the lowest (cheapest) (S104). When the usage fee is calculated based on FIGS. 3 and 4, as to a combination of the run mode (smoothing: invalid, compression: invalid) and the business operator 2, the usage fee to execute the energy saving service is the cheapest. Accordingly, the service integrated operation unit 106 determines that the energy saving service 1 is to be executed with the run mode (smoothing: invalid, compression: invalid) on the service execution environment of the business operator 2.

Next, the service integrated operation unit 106 notifies the environment construction unit 107 of decision information of the hosting service business operator (S105).

Next, the environment construction unit 107 constructs a service execution environment necessary for executing the energy saving service 1 on the hosting service business operator system of the business operator 2 (S106). Here, by using createVM service, the environment construction unit 107 creates a virtual server on the hosting service business operator system of the business operator 2. Furthermore, the environment construction unit 107 installs a middleware and a library necessary for executing the energy saving service 1.

Next, the environment construction unit 107 writes an IP address and a port number of the virtual server created by createVM service, into the service status storage 109 (S107).

Next, the service integrated operation unit 106 requests the service control unit 108 to execute the service (S108). Here, the service integrated operation unit 106 provides information of the run mode of which the usage fee is the cheapest. In this example, the run mode (smoothing: invalid, compression: invalid) is provided.

Next, the service control unit 108 copies a program and a configuration file of the energy saving service 1 (stored in the service program storage 102) into the virtual server, and executes the service. Here, an IP address of the virtual server is acquired from the service status storage 109. Furthermore, the service control unit 108 sets the run mode (provided from the service integrated operation unit 106) to the energy saving service 1.

The energy saving service 1 starts operating based on the run mode, and executes the energy saving control for the building 300.

Thus far, processing flow of the service operation apparatus of the first embodiment is already explained.

As mentioned-above, according to the service operation apparatus 100 of the first embodiment, the usage fee is calculated for each combination of the business operator and the run mode. Accordingly, a combination of the service execution environment and the run mode of which the usage fee is the cheapest can be determined. As a result, a cost required for providing the energy saving service can be reduced.

Moreover, in the first embodiment, a server spec (shown in FIG. 3) of the virtual server of the business operator 1 is different from a server spec (shown in FIG. 4) of the virtual server used for calculating the resource consumption. On the other hand, a server spec (shown in FIG. 3) of the virtual server of the business operator 2 is same as a server spec (shown in FIG. 4) of the virtual server used for calculating the resource consumption. In above explanation, irrespective of the server spec, the usage fee is calculated by substituting the resource consumption (shown in FIG. 4) for the account method (shown in FIG. 3), and a server spec is not taken into consideration. However, in case of calculating a usage fee, the usage fee can be increased or decreased based on the server spec.

In the first embodiment, as to all combinations of the hosting service business operators (two business operators 1 and 2 in FIG. 3) and all run modes (four run modes in FIG. 4), the usage fee is calculated. However, the usage fee of all combinations may not be calculated. For example, by selecting a part of all combinations of the business operators and the run modes at random, one combination of which the usage fee is the cheapest may be selected from the part of combinations. In this way, by not calculating the usage fee of all combinations, a time to calculate the usage fee can be reduced.

In the first embodiment, the service operation apparatus 100 operates one energy saving service. However, the service operation apparatus 100 may operate a plurality of energy saving services. When the plurality of energy saving services is operated, the service operation apparatus 100 executes processing of FIG. 5 for each service.

In the first embodiment, the service operation apparatus 100 selects one business operator for one service. However, a plurality of business operators may be selected for one service. By executing one service on service execution environments provided by the plurality of business operators, continuity of the service can be strengthened. In this case, in order of cheap usage fee, the service integrated operation unit 106 selects at least two business operators. Then, the service integrated operation unit 106 notifies the environment construction unit 107 and the service control unit 108 of information of the at least two business operators. Other processing is the same as above-mentioned processing.

In the first embodiment, among all usage fees calculated, one combination of the business operator and the run mode corresponding to the cheapest usage fee is selected. However, one combination corresponding to the cheapest usage fee may not be selected. For example, assume that a condition except for the usage fee is taken into consideration. As to a combination corresponding to the second cheapest usage fee, if the condition of this combination is better than the condition of a combination corresponding to the cheapest usage fee, the combination corresponding to the second cheapest usage fee may be selected. In this way, when a combination of the business operator and the run mode is selected, the usage fee may be regarded as one of decision references.

In the first embodiment, as to all combinations of the business operators and the run modes, the account method is a calculation formula of which variable is a resource consumption determined by the run mode. However, the account method is not limited to this calculation formula. For example, the account method may be a calculation formula not including the resource consumption. Furthermore, the account method may be a fixed fee. In this case, by comparing usage fees calculated by each account method, a combination of the business operator and the run mode corresponding to the cheapest usage fee may be selected.

In the first embodiment, from a plurality of business operators and a plurality of run modes, a combination of one business operator and one run mode is selected. However, for example, from one business operator and a plurality of run modes, a combination of the one business operator and one run mode may be selected.

In the first embodiment, the service execution environment is rented. However, the service execution environment may be purchased.

In the first embodiment, the service provider rents the service execution environment from the hosting service business operator. However, the service provider may provide a service by using a service execution environment retained by the service provider. By including this case, a method for constructing the service execution environment corresponding to the lowest cost may be selected. For example, as to the case that the service execution environment is rented from the business operator, a cost is calculated by using the method of the first embodiment. As to the case that a service is provided by using a service execution environment retained by the service provider, a cost is calculated by using a conventional calculation method thereof. By comparing the costs of both cases, one case corresponding to the lowest cost can be checked.

In the first embodiment, the service execution environment is a virtual server. However, the service execution environment is not limited to the virtual server. For example, the service execution environment may be a physical server.

In the first embodiment, the hosting service business operator provides the virtual server. However, the hosting service business operator may be a business operator who provides a physical server, or a business operator who provides a set of a middleware and the virtual server or the physical server. Moreover, in a technical region of cloud computing, a business operator who provides the physical server or the virtual server is equivalent to IaaS (Infrastructure as a Service) business operator, and a business operator who provides a set of the middleware and the virtual server or the physical server is equivalent to PaaS (Platform as a Service) business operator.

In the first embodiment, the energy saving service is explained as the example. However, a service provided by the service provider is not limited to the energy saving service.

In the first embodiment, the service operation apparatus 100 includes the hosting service business operator storage 101, the service program storage 102, the resource consumption storage 103, the cost calculation unit 104, the cost storage 105, the service integrated operation unit 106, the environment construction unit 107, the service control unit 108, and the service status storage 109. These units are loaded onto one physical apparatus. However, construction of these units is not limited to this example. For example, these units may be prepared by dividing into a plurality of physical apparatuses. Briefly, the service operation apparatus 100 has only to function as one apparatus, and whether the component thereof is loaded onto one physical apparatus is irrelevant.

### The Second Embodiment

Next, a service operation apparatus 200 according to the second embodiment is explained.

In the first embodiment, at a timing to start execution of the energy saving service, processing to select a combination of the service execution environment and the run mode corresponding to the cheapest usage fee is already explained.

In the service operation apparatus 2100 of the second embodiment, while the energy saving service is being executed, based on change of the account method of the business operator or change of the resource consumption of the service, the service execution environment and the run mode can be dynamically changed.

Hereinafter, while the service is being executed, a merit that the service execution environment and the run mode can be dynamically changed is explained.

After beginning to execute the energy saving service, this service does not basically stop to be executed. For example, as to a comfort air conditioning service, after beginning to execute, this service continues to execute the energy saving control for air conditioning at an interval of ten minutes. Only when an accident has occurred or maintenance thereof is executed, the comfort air conditioning service is stopped. However, after beginning to execute the service, the account method of the business operator or the resource consumption of the service often changes. As a result, a combination of the service execution environment and the run mode corresponding to the cheapest cost also changes.

Accordingly, in the service operation apparatus 2100 of the second embodiment, even if the service is being executed, based on change of the account method of the business operator or change of the resource consumption of the service, the service execution environment and the run mode are dynamically changed. As a result, a cost to operate the service can be reduced.

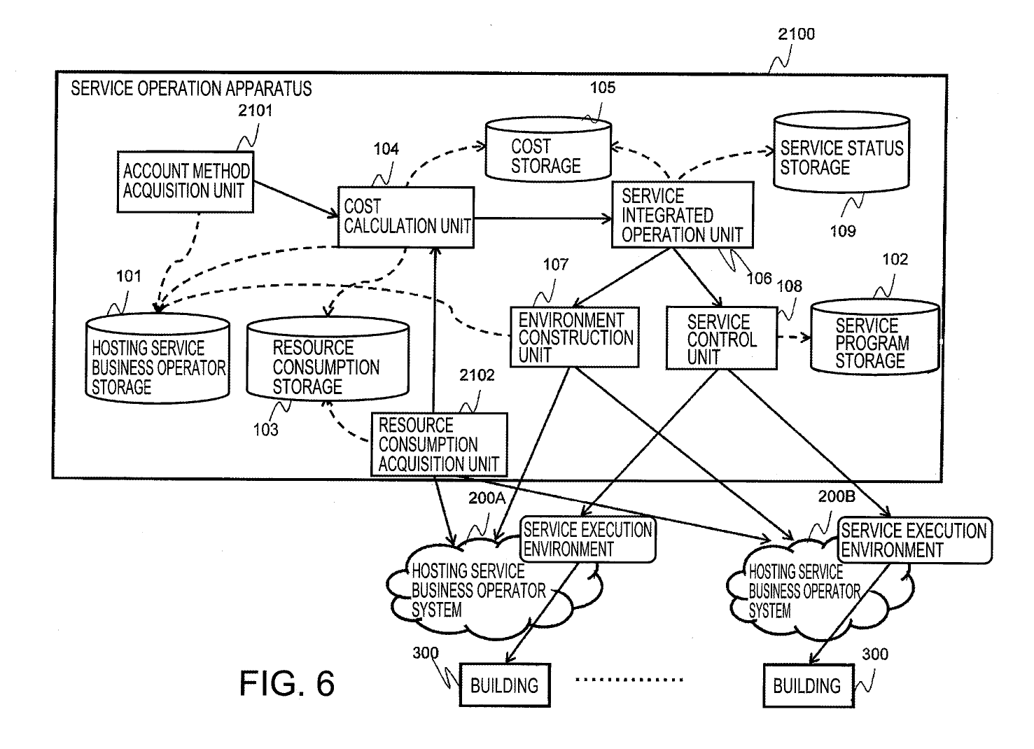

FIG. 6 is a block diagram of the service operation apparatus 2100 according to the second embodiment.

In addition to component of the service operation apparatus 100 of the first embodiment, the service operation apparatus 2100 includes an account method acquisition unit 2101 and a resource consumption acquisition unit 2102. Other units in the service operation apparatus 2100 are same as those of the service operation apparatus 100.

The account method acquisition unit 2101 periodically acquires the account method of the hosting service business operator. When the account method is changed, the account method acquisition unit 2101 updates the account method stored in the hosting service business operator storage 101. For example, the account method can be acquired by referring to Web site of the hosting service business operator.

The resource consumption acquisition unit 2102 acquires the resource consumption of the energy saving service already executed. When the resource consumption is changed, the resource consumption acquisition unit 2102 updates the resource consumption stored in the resource consumption storage 103. For example, the resource consumption (such as a consumption of a CPU of the virtual server and a network band) is periodically collected from the virtual server which executes the energy saving service.

Next, processing of the service operation apparatus 2100 of the second embodiment is explained.

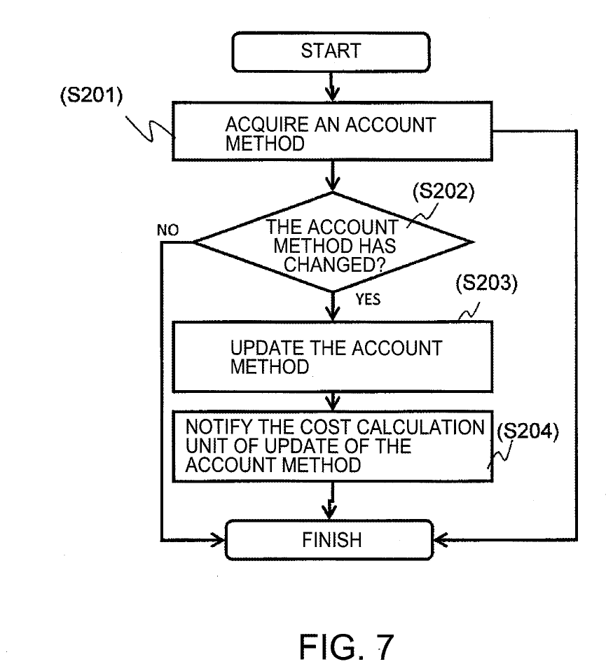

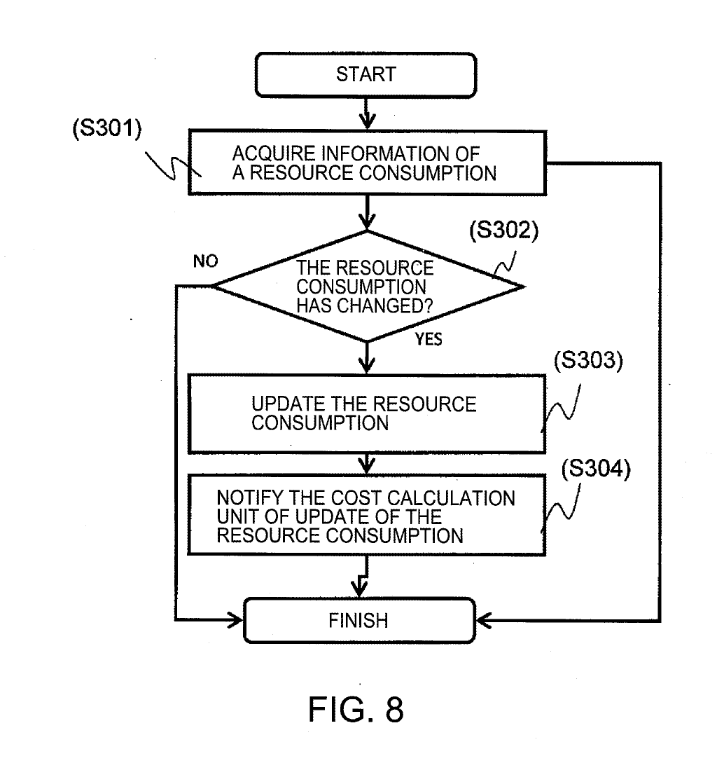

Hereinafter, first, processing of the account method acquisition unit 2101 and the resource consumption acquisition unit 2102 is explained. Second, when processing of FIG. 7 or FIG. 8 is executed, processing of the service operation apparatus 2100 is explained.

FIG. 7 is a flow chart of processing of the account method acquisition unit 2101. First, the account method acquisition unit 2101 acquires an account method of the hosting service business operator at a predetermined interval (S201).

Next, the account method acquisition unit 2101 decides whether the account method (acquired at S201) is different from account methods stored in the hosting service business operator storage 101 (S202).

Next, when the account method is different from account methods stored in the hosting service business operator storage 101 (Yes at S202), the account method acquisition unit 2101 updates an account method (corresponding to the account method acquired at S201) among the account methods stored in the hosting service business operator storage 101 by the account method acquired at S201 (S203).

Next, when the account method is updated at S203, the account method acquisition unit 2101 notifies the cost calculation unit 104 of update thereof (S204).

FIG. 8 is a flow chart of processing of the resource consumption acquisition unit 2102 of the second embodiment.

First, the resource consumption acquisition unit 2102 acquires a resource consumption of a server which executes the energy saving service, at a predetermined interval (S301).

Next, the resource consumption acquisition unit 2102 decides whether the resource consumption (acquired at S301) is different from contents stored in the resource consumption storage 103 (S302).

Next, when the resource consumption (acquired at S301) is different from the contents stored in the resource consumption storage 103 (Yes at S302), the resource consumption acquisition unit 2102 updates the contents stored in the resource consumption storage 103 by the resource consumption acquired at S301 (S303).

Next, when the contents stored in the resource consumption storage 103 is updated at S303, the resource consumption acquisition unit 2102 notifies the cost calculation unit 104 of update thereof (S304).

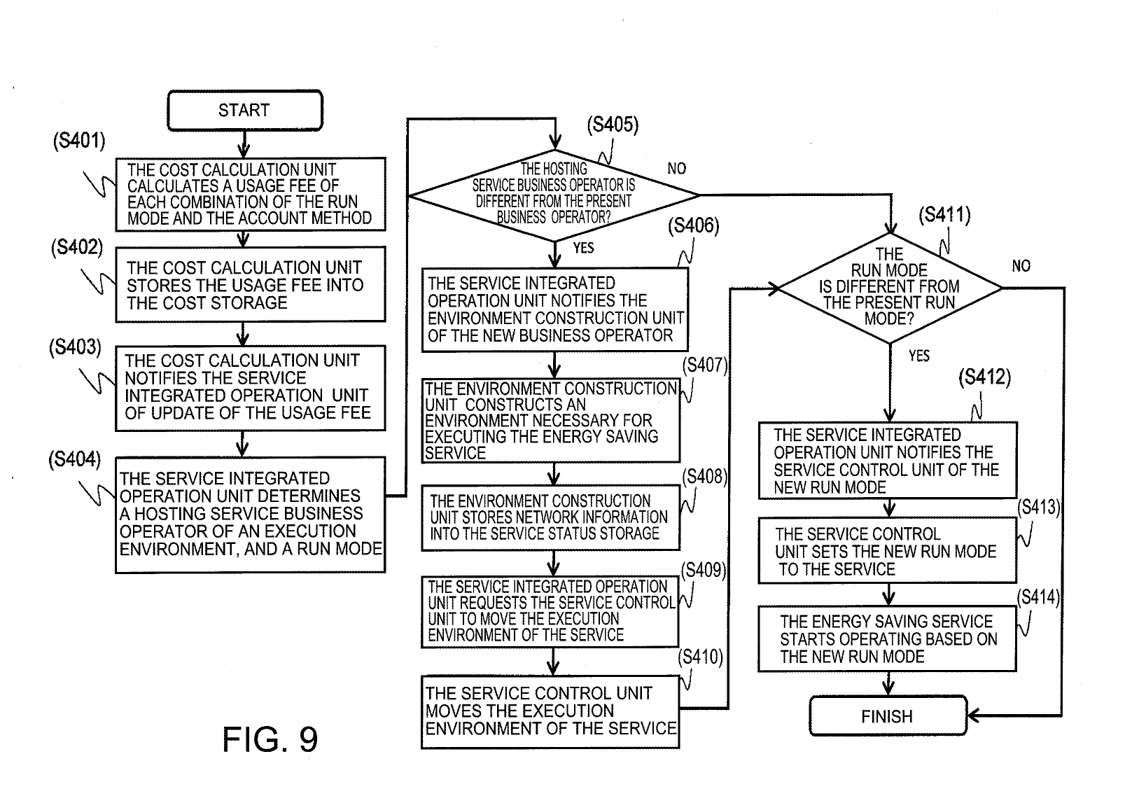

FIG. 9 is a flow chart of processing of the service operation apparatus 2100. Concretely, FIG. 9 is a flow chart of processing for the service operation apparatus 2100 to dynamically change the service execution environment and the run mode.

When the account method or the resource consumption is updated by processing of FIG. 7 or FIG. 8, the service operation apparatus 2100 executes processing of FIG. 9 for all services being operated.

First, when the cost calculation unit 104 accepts a notification of update from the account method acquisition unit 2101 or the resource consumption acquisition unit 2102, in the same way as the method explained in the first embodiment, the cost calculation unit 104 calculates a usage fee of each combination of each run mode of the energy saving service 1 and an account method of each business operator (S401).

Next, the cost calculation unit 104 stores the usage fee into the cost storage 105 (S402).

Next, the cost calculation unit 104 notifies the service integrated operation unit 106 of update of the usage fee related to the energy saving service 1 (S403).

Next, by referring to the cost storage 105, the service integrated operation unit 106 determines a combination of the hosting service business operator and the run mode of which the usage fee is the cheapest (S404). For example, assume that the business operator 1 is selected and the run mode (smoothing: valid, compression: invalid) is selected.

Next, the service integrated operation unit 106 decides whether the business operator 1 is different from “a business operator ID” stored in the service status storage 109 (S405).

Next, when the business operator 1 is different from the business operator ID (Yes at S405), the service integrated operation unit 106 notifies the environment construction unit 107 of information of the business operator 1 determined at S404 (S406).

Next, on a hosting service business operator system of the business operator 1, the environment construction unit 107 constructs an environment necessary for executing the energy saving service 1 (S407). A method for constructing the environment is same as the method explained in the first embodiment.

Next, the environment construction unit 107 stores an IP address and a port number of the virtual server into the service status storage 109 (S408).

Next, the service integrated operation unit 106 notifies the service control unit 108 of moving of the service execution environment (S409).

Next, when the service control unit 108 accepts a notification of moving of the service execution environment, the service control unit 108 moves the service from the present service execution environment to a service execution environment newly constructed (S410). This moving is realized by copying the service program from a source execution environment to a destination execution environment.

Next, the service integrated operation unit 106 decides whether the run mode (determined at S404) is different from the present run mode (S411).

Next, when the run mode (determined at S404) is different from the present run mode (Yes at S411), the service integrated operation unit 106 notifies the service control unit 108 of configuration of the run mode determined at S404 (S412). In this example, the run mode (smoothing: valid, compression: invalid) is notified.

Next, the service control unit 108 changes the run mode of the service being operated by the run mode of configuration notified (s413). Here, the service control unit 108 acquires an IP address of the server to execute the service from the service status storage 109.

Next, the energy saving service operates based on the run mode newly configured, and executes the energy saving control for a building (S414).

As mentioned-above, according to the service operation apparatus 2100 of the second embodiment, whenever the account method or the resource consumption is periodically updated, a combination of the execution environment and the run mode corresponding to the cheapest cost is determined. Accordingly, the cost required for providing the service (operating for a long period) can be reduced.

Thus far, in the first and second embodiments, when the service provider rents a service execution environment from the hosting service business operator, a cost required for providing the service can be reduced.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for operating a service, comprising:
an environment provider storage to store a plurality of account methods corresponding to environment providers providing service execution environments, each account method being a method for calculating a usage fee for each service execution environment;
a resource consumption storage to store a plurality of resource consumptions corresponding to run modes, each run mode being an operation pattern for each service execution environment to execute the service, each resource consumption being a consumption of resources of the service execution environment while executing the service in each run mode;
a calculation unit configured to calculate usage fees based on combinations of one of the account methods corresponding to the environment providers and one of the resource consumptions corresponding to the run modes; and
an integrated operation unit configured to select at least one combination of a selected environment provider and a selected run mode, based on the usage fees calculated by the calculation unit.

2. The apparatus according to claim 1, further comprising:
a service control unit configured to execute the service in the selected run mode of the at least one combination, on the service execution environment provided by the selected environment provider of the at least one combination.

3. The apparatus according to claim 2, further comprising:
an account method acquisition unit configured to acquire an account method of an environment provider; wherein,
when the account method acquired by the account method acquisition unit is different from the account method corresponding to the environment provider stored in the environment provider storage,
the calculation unit calculates a usage fee based on the account method acquired by the account method acquisition unit,
the integrated operation unit selects a combination again, based on the usage fee calculated based on the account method acquired by the account method acquisition unit, and,
when an environment provider of the combination selected again is different from the environment provider providing the service execution environment executing the service,
the service control unit moves the service to a service execution environment provided by the environment provider of the combination selected again.

4. The apparatus according to claim 2, further comprising:
a resource consumption acquisition unit configured to acquire a resource consumption of the service execution environment to execute the service in a run mode; wherein,
when the resource consumption acquired by the resource consumption acquisition unit is different from the resource consumption corresponding to the run mode stored in the resource consumption storage,
the calculation unit calculates a usage fee based on the resource consumption acquired by the resource consumption acquisition unit,
the integrated operation unit selects a combination again, based on the usage fee calculated based on the resource consumption acquired by the resource consumption acquisition unit, and,
when an environment provider of the combination selected again is different from the environment provider providing the service execution environment executing the service,
the service control unit moves the service to a service execution environment provided by the environment provider of the combination selected again.

5. The apparatus according to claim 3,
when a run mode of the combination selected again is different from the run mode in which the service is executed,
wherein the service control unit controls the service to be executed in the run mode of the combination selected again.

6. The apparatus according to claim 4,
when a run mode of the combination selected again is different from the run mode in which the service is executed,
wherein the service control unit controls the service to be executed in the run mode of the combination selected again.

7. The apparatus according to claim 1,
wherein the calculation unit calculates the usage fee of a part of each of the combinations.

8. The apparatus according to claim 1,
wherein the account method is represented as a calculation formula of which variables are the resource consumption.

9. A method for operating a service, comprising:
storing a plurality of account methods corresponding to environment providers providing service execution environments, each account method being a method for calculating a usage fee for each service execution environment;
storing a plurality of resource consumptions corresponding to run modes, each run mode being an operation pattern for each service execution environment to execute the service, each resource consumption being a consumption of resources of the service execution environment while executing the service in each run mode;
calculating usage fees based on combinations of one of the account methods corresponding to the environment providers and one of the resource consumptions corresponding to the run modes; and
selecting at least one combination of a selected environment provider and a selected run mode, based on the usage fees calculated.

10. A non-transitory computer readable medium for causing a computer to perform a method for operating a service, the method comprising:
storing a plurality of account methods corresponding to environment providers providing service execution environments, each account method being a method for calculating a usage fee for each service execution environment;
storing a plurality of resource consumptions corresponding to run modes, each run mode being an operation pattern for each service execution environment to execute the service, each resource consumption being a consumption of resources of the service execution environment while executing the service in each run mode;
calculating usage fees based on combinations of one of the account methods corresponding to the environment providers and one of the resource consumptions corresponding to the run modes; and
selecting at least one combination of a selected environment provider and a selected run mode, based on the usage fees calculated.
